(19) United States
(12) Patent Application Publication
(10) Pub. No.: US 2017/0127045 A1
(43) Pub. Date: May 4, 2017

(54) IMAGE CALIBRATING, STITCHING AND DEPTH REBUILDING METHOD OF A PANORAMIC FISH-EYE CAMERA AND A SYSTEM THEREOF

(71) Applicant: Toppano Co., Ltd., Taipei (TW)

(72) Inventors: Tzong-Li Lin, Taipei City (TW); Hong-Shiang Lin, Taipei City (TW); Chao-Chin Chang, Taipei City (TW)

(21) Appl. No.: 15/332,047

(22) Filed: Oct. 24, 2016

(30) Foreign Application Priority Data
Oct. 28, 2015 (TW) 104153360

(51) Int. Cl. H04N 13/02; H04N 5/232; G06N 99/00; H04N 13/00; G06T 7/00; G06T 19/20; H04N 5/374; H04N 5/247

(52) U.S. Cl. CPC H04N 13/0246; H04N 5/374; H04N 13/0242; H04N 5/23238; H04N 5/247; H04N 13/0007; H04N 13/026; H04N 13/0282; G06T 7/0018; G06T 19/20; G06N 99/005; H04N 2213/001; H04N 2213/003; G06T 2207/20221

(57) ABSTRACT

The present invention provides an image calibrating, stitching and depth rebuilding method of a panoramic fish-eye camera comprising the following steps of: establishing a panoramic optical target space; using the panoramic fish-eye camera for shooting the panoramic optical target space's panoramic image; establishing an internal parameter calibration model for the panoramic fish-eye camera; establishing an image stitching parameter model and a space depth transformation parameter model of the panoramic image and the panoramic optical target space; and using the internal parameter calibration model, the image stitching model and the depth transformation parameter model to calibrate the panoramic image for generating a 3D panoramic image. Compared to the prior art, the present invention can optimize the calibration parameters by accumulating all the camera data and executing a machine learning for increasing the computing efficiency.

### BACKGROUND OF THE INVENTION

1. Field of the Invention

The present invention relates to an image calibrating, stitching and depth rebuilding method of a panoramic fish-eye camera and a system thereof, more particularly, to the image calibrating, stitching and depth rebuilding method of a panoramic fish-eye camera and a system thereof utilized for calibrating a panoramic image by means of an image stitching parameter model (i.e. external calibration parameter model), a space depth transformation parameter model acquired from a panoramic optical target space shot by a panoramic fish-eye camera and an internal calibration parameter of the panoramic fish-eye camera.

2. Description of the Prior Art

When the cameras are created in the world, people begin to record their daily life or important events in history by means of images. As to the technique and equipment of photography, low definition black and white pictures have been developed to high definition color pictures and to the high speed cameras which can shoot two billion frames per second in advance. Additionally, as to the visual effect of photography, not only the planar images but also the 3D images can be shot.

In the prior art, the 3D images are shot by utilizing a twin-lens camera of a 3D camera. But the 3D images can be shot within some angles of view which are limited by the photographic scopes of the equipment, or the 360-degree surrounding panoramic images are shot by a photographer who holds a camera and turns around. However, the photographer must spend much time for shooting the panoramic images by utilizing this method. Therefore, a method for shooting a 3D panoramic image by utilizing several 3D cameras at the same time is provided

The configurations of three cameras to tens of cameras are existed now, but they all belong to the monocular vision system. And the depth information cannot be computed or acquired by utilizing parallax because less the photographic scopes overlapping of the camera. And the depth information is required for the 3D information of the virtual reality and the augmented reality. Consequently, how to get the 3D depth information by using the cameras is very important.

### SUMMARY OF THE INVENTION

Therefore, the present invention provides an image calibrating, stitching and depth rebuilding method of a panoramic fish-eye camera. The method is utilized for calibrating a panoramic image shot by a panoramic fish-eye camera for generating a 3D panoramic image which comprises the object depth information. The panoramic fish-eye camera comprises four fish-eye lens and four CMOS sensor modules, wherein each one of the fish-eye lens can be attached with a CMOS sensor module. The method provided by the present invention comprises the following steps:

establishing a panoramic optical target space; utilizing the panoramic fish-eye camera for shooting the panoramic image of the panoramic optical target space; establishing an internal parameter calibration model of the panoramic fish-eye camera; establishing an image stitching parameter model (external parameter calibration model) of the panoramic image and the panoramic optical target space; establishing a space depth transformation parameter model of the panoramic image and the panoramic optical target space; and utilizing the image stitching parameter model, the space depth transformation parameter model and the internal parameter calibration model to generate a 3D panoramic image, which comprises the panoramic depth information.

Furthermore, the space depth transformation parameter model is a transformation model between a 2D planar image and the depth of object in 3D space; the internal parameter calibration model is the coordinate transformation model between the fish-eye lens and the CMOS sensor modules of the panoramic fish-eye camera; and the image stitching parameter model (external parameter calibration model) is used for a panoramic image stitching parameter model by means of computing the relationships between the physical body and the space coordinate of the four fish-eye lens from the images shot by the panoramic fish-eye camera.

The method provided by the present invention further comprises the following step: optimizing the parameters by means of collecting the internal parameter calibration model, the image stitching parameter model (external parameter calibration model) and the space depth transformation parameter model from each of the panoramic fish-eye cameras. And an optimization model is acquired by means of a machine learning method for optimizing the parameters.

The present invention provides an image calibrating, stitching and depth rebuilding system of a panoramic fish-eye camera for generating a panoramic image and panoramic depth information, and the panoramic image and panoramic depth information are calibrated to generate a 3D panoramic image. The system provided by the present invention comprises a panoramic fish-eye camera, a module for generating panoramic image and panoramic depth information and a computing module. The computing module can be a cloud computing module or be comprised in the cameras.

The panoramic fish-eye camera comprises four fish-eye lens and four CMOS sensor modules, wherein each one of the fish-eye lens can be attached with a CMOS sensor module. The intersection angle of the shooting directions of the neighboring fish-eye lens is 90 degrees. The module for generating panoramic image and panoramic depth information is electrically connected with the panoramic fish-eye camera, comprising an internal parameter calibration module, an image stitching module and a space depth transformation parameter module.

An internal parameter calibration model is stored in the internal parameter calibration module, utilized for providing the required parameters of the coordinate transformation model between the fish-eye lens and the CMOS sensor modules. An image stitching parameter model is stored in the image stitching module, utilized for stitching the panoramic images shot by the panoramic fish-eye camera to a panoramic picture. A space depth transformation parameter model is stored in the space depth transformation parameter module, utilized for providing a transformation model between a 2D planar image and the object depth in 3D space to the panoramic fish-eye camera, to get the panoramic depth information of each pixel in the panoramic images. The computing module is electrically connected with the module for generating the panoramic image and the panoramic depth information, utilized for calibrating and stitching the panoramic picture and the panoramic depth information to generate the 3D panoramic image.

The system provided by the present invention further comprises an optimization module. The optimization module is electrically connected with the module for generating panoramic image and panoramic depth information. The optimization module can accumulate a parameter data by means of collecting the internal parameter calibration model, the image stitching parameter model and the space depth transformation parameter model from each of the panoramic fish-eye cameras, and then optimize the parameter data by a machine learning method.

Compared to the prior art, the panoramic images and depth information can be acquired quickly by the present invention, and the calibration parameters can be optimized by means of a machine learning method to accumulate data. Therefore, the quality of the panoramic stitching picture and the precision of the panoramic depth information are promoted, so as to simplify the algorithm of 3D depth and to enhance the computing efficiency. Furthermore, the simplified algorithm of 3D depth can be implanted to be executed on a single-chip, so the image calibration system of the fish-eye camera can be calibrated instantly and portable conveniently. Additionally, the required calibration process of production will be simplified and time saved thereof.

### BRIEF DESCRIPTION OF THE APPENDED DRAWINGS

FIG. 1 is a method flowchart according to one embodiment of the present invention.

FIG. 2 is a method flowchart according to one embodiment of the present invention.

FIG. 3 is a front view drawing of a panoramic fish-eye camera according to another embodiment of the present invention.

FIG. 4 is a top view drawing of a panoramic fish-eye camera according to another embodiment of the present invention.

FIG. 5 is a system functional block diagram according to another embodiment of the present invention.

### DETAILED DESCRIPTION OF THE INVENTION

In order to allow the advantages, spirit and features of the present invention to be more easily and clearly understood, the embodiments and appended drawings thereof are discussed in the following. However, the present invention is not limited to the embodiments and appended drawings.

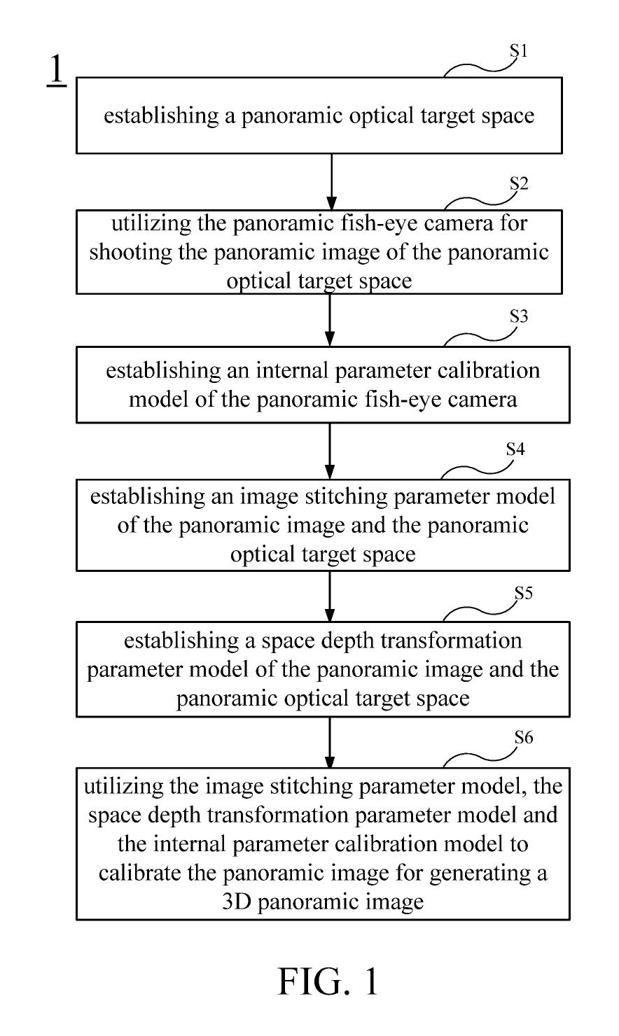

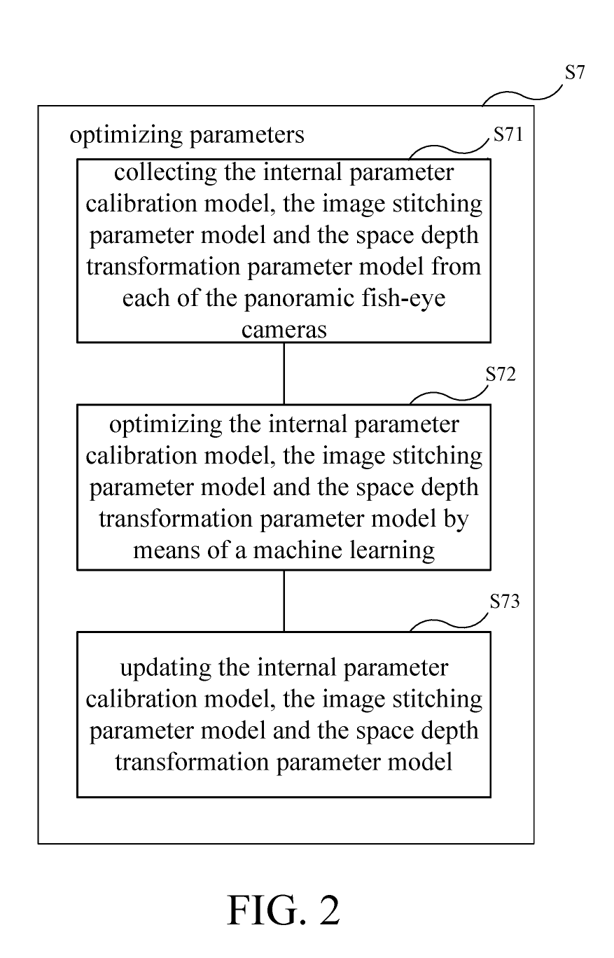

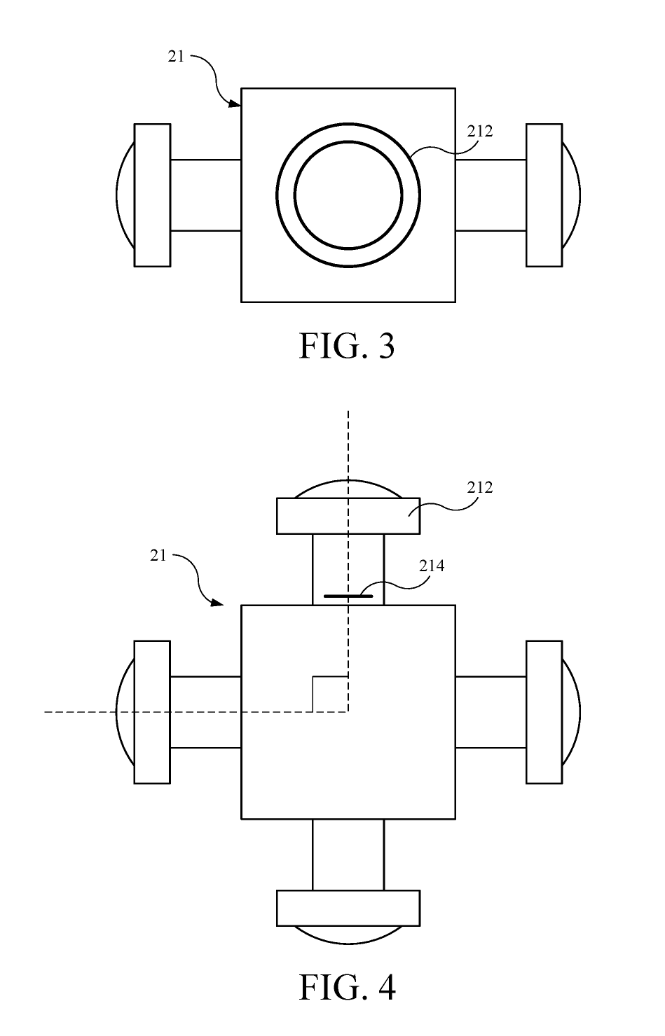

Please refer to FIG. 1 to FIG. 4. FIG. 1 and FIG. 2 are method flowcharts according to one embodiment of the present invention. FIG. 3 is a front view drawing of a panoramic fish-eye camera according to another embodiment of the present invention. FIG. 4 is a top view drawing of a panoramic fish-eye camera according to another embodiment of the present invention.

In one embodiment, the present invention provides an image calibrating, stitching and depth rebuilding method 1 of a panoramic fish-eye camera. The method 1 is utilized for calibrating a panoramic image shot by a panoramic fish-eye camera 21 for generating a 3D panoramic image. The panoramic fish-eye camera 21 comprises four fish-eye lens 212 and four CMOS sensor modules 214, wherein each one of the fish-eye lens 212 can be attached with a CMOS sensor module 214. The method 1 comprises the following steps:

(Step S1) establishing a panoramic optical target space;

(Step S2) utilizing the panoramic fish-eye camera for shooting the panoramic image of the panoramic optical target space;

(Step S3) establishing an internal parameter calibration model of the panoramic fish-eye camera;

(Step S4) establishing an image stitching parameter model (external parameter calibration model) of the panoramic image and the panoramic optical target space;

(Step S5) establishing a space depth transformation parameter model of the panoramic image and the panoramic optical target space; and

(Step S6) utilizing the image stitching parameter model, the space depth transformation parameter model and the internal parameter calibration model to generate a 3D panoramic image, which comprises the panoramic depth information.

Additionally, the execution sequence of step S4 and step S5 is not limited herein, step S4 and step S5 may be executed simultaneously, or step S5 may be executed earlier than step S4.

The details of the aforementioned steps are illustrated as follows. First, the depth of objects cannot be judged easily from the images shot by a monocular vision camera directly. And the actual depth cannot be judged easily because the images shot by the fish-eye lens 212 are deformed. Therefore, in order to establish a relationship between the object depth in 3D space and the 2D planar image, the step S1 is executed first: establishing a panoramic optical target space, and several targets marked with the distance of the panoramic fish-eye camera 21 set in a space. And then the step S2 is executed to utilize the panoramic fish-eye camera 21 for shooting the panoramic image of the panoramic optical target space to find out the corresponding relationships between the targets in the space and the targets in the panoramic images.

Before finding out the corresponding relationships between the targets in the space and the targets in the panoramic images, the images shot by the fish-eye lens 212 are deformed because of the spherical shapes of the fish-eye lens 212. Therefore, the corresponding relationships of the fish-eye lens 212 and the CMOS sensor modules 214 in the fish-eye camera 21 shall be found out, i.e. the internal calibration parameter shall be found out. As a result, the step S3 is executed in the present invention to establish an internal parameter calibration model of the panoramic fish-eye camera. The set locations of the CMOS sensor modules 214 in the fish-eye camera 21 are marked on the top view drawing of the present invention for the convenience of explanation.

Because the fish-eye lens 212 have semi-spherical shapes substantially and the CMOS sensor modules 214 have planar shapes, the transformation of the spherical coordinate system and the rectangular coordinate system is executed first, to find out the corresponding projection relationships of any point coordinate Xs on the fish-eye lens 212 (the spherical coordinate system) and the image planar coordinate Xd of the CMOS sensor modules 214 (the XY plane of the rectangular coordinate system). After finding out the corresponding projection relationships thereof, the corresponding relationships of the image plane coordinate Xd of the CMOS sensor modules 214 and each sensor modules 214 shall be established by using the

$$Xp = [ \begin{matrix}u \\ v\end{matrix} ] = [ \begin{matrix}{m}_{u} & 0 \\ 0 & {m}_{v}\end{matrix} ] [ \begin{matrix}{x}_{d} \\ {y}_{d}\end{matrix} ] + [ \begin{matrix}{u}_{0} \\ {v}_{0}\end{matrix} ]$$

Wherein Xₚ is the coordinate of pixels on the CMOS sensor modules 214; mᵤ and mᵥ are the amount of displacement of each pixel generated on the plane; uₒ and vₒ are the origin points of the image plane coordinate of the CMOS sensor modules, i.e. the starting points of the coordinate transformation. The step S3 of the present invention is accomplished through the above-mentioned processes by establishing an internal parameter calibration model of the panoramic fish-eye camera for transforming any coordinate point Xₛ of the fish-eye lens 212 to the coordinate Xₚ of pixels on the CMOS sensor modules 214, and then the internal calibration is executed.

For establishing the corresponding relationships between the images shot by the individual fish-eye lens and the actual panoramic images to stitch the panoramic picture, the step S4 shall be executed to establish an image stitching parameter model (the external parameter calibration model) of the panoramic image and the panoramic optical target space. By utilizing the target, like the four checks with black and white alternative of the checkerboard pattern, to establish the relationships between the physical location and the image plane coordinate of the four fish-eye lens by detecting the characteristic point of the target. And then the relationships between the physical body and the space coordinate of the four fish-eye lens 212 from the images shot by the four fish-eye lens 212 are utilized as the image stitching parameter model.

As shown in FIG. 3, in one embodiment of the present invention, the panoramic fish-eye camera 21 comprises four fish-eye lens 212. In order to stitch the images shot by the four fish-eye lens 212, the relative positions of the four fish-eye lens 212 shall be corrected. Therefore, the position relationships of the four fish-eye lens 212 are expressed as the following formula in the present invention.

x_{c}=RX+t

Wherein X is the image plane (xy plane) of one lens in a position of 3D space; X_{c} is the intersected position of the image planes between the viewing angles of the other lens and the aforementioned lens in the 3D space; R which is shown as matrix is the rotation rate of the lens optical axis (i.e. about the shooting direction, z axis); t is the required displacement distance of the rotated image plane to correspond with the characteristic points of the intersected planes. In brief, the image plane position of one fish-eye lens is used as the original point, the lens optical axis is used as the z axis, and the image plane is used as the xy plane. And a predetermined coordinate system shall be established to position the optical axis direction of the other fish-eye lens and the image plane position for dealing with the images from the four fish-eye lens more conveniently.

After correcting the relative positions of the four fish-eye lens 212, an image stitching parameter model (external parameter calibration model) shall be established. Referring to in FIG. 3 shown as follows, the intersection angle (shown in dotted lines) of the shooting directions of the neighboring fish-eye lens 212 in the panoramic fish-eye camera 21 is 90 degrees, and the viewing angle of the fish-eye lens 212 is 180 degrees, so at least one overlapping scene of the images shot by the neighboring fish-eye lens 212 respectively is existed. In step S4, the overlapping scene shall be found out from the images shot by the neighboring fish-eye lens 212 respectively, is executed. First, one pixel of the images shot by one of the fish-eye lens 212 is appointed. And a characteristic vector is defined according to the color changing around the pixel. Then the corresponding pixels shall be found out in the images shot by the neighboring fish-eye lens 212. After the corresponding relations of at least one characteristic vector and pixel are established, i.e. the image stitching parameter model (external parameter calibration model) is established, the step S4 is accomplished.

Then the step S5 is executed to establish a space depth transformation parameter model of the panoramic image and the panoramic optical target space. After utilizing the panoramic images of the panoramic optical target space shot by the panoramic fish-eye camera 21, the panoramic images of the panoramic optical target space is acquired, and the distance between the target position of the panoramic optical target space and the panoramic fish-eye camera 21 has been known, the step S5 is aimed for establishing a transformation model judged by a software system of the corresponding relationships between the target (i.e. the 2D planar image) of the panoramic images and the target (i.e. 3D space) object depth of the panoramic optical target space to acquire a panoramic depth information. Therefore, the distance (i.e. depth) between the panoramic fish-eye camera 21 and the objects of images from the panoramic images shot thereby can be computed by the present invention, the image calibrating, stitching and depth rebuilding method 1 of the panoramic fish-eye camera 21, for calibrating the panoramic 3D images.

By executing the steps S1 to S5, the panoramic images shot by the panoramic fish-eye camera 21, the internal parameter calibration model of the panoramic fish-eye camera, the image stitching parameter model (i.e. external parameter calibration model) and the space depth transformation parameter model of the panoramic image and the panoramic optical target space are acquired. Then step S6 is executed for utilizing the image stitching parameter model, the space depth transformation parameter model and the internal parameter calibration model to generate a 3D panoramic image, which comprises the panoramic depth information.

Furthermore, the aforementioned steps S1 to S5 shall be executed on each of the fish-eye cameras 21 due to the manufacturing difference of the fish-eye cameras 21, so the fish-eye cameras 21 cannot be delivered directly after being produced. A great amount of time and manpower for measurement and calibration will be spent if the fish-eye cameras 21 are mass-produced. Therefore, the present invention of the image calibrating, stitching and depth rebuilding method 1 of the panoramic fish-eye camera 21 further comprises a step S7 for optimizing the parameters. The step S7 comprises a step S71 for collecting the internal parameter calibration model, the image stitching parameter model and the space depth transformation parameter model from each of the panoramic fish-eye cameras; a step S72 for optimizing the internal parameter calibration model, the image stitching parameter model and the space depth transformation parameter model by means of a machine learning, and a step S73 for updating the internal parameter calibration model, the image stitching parameter model and the space depth transformation parameter model.

By continuously collecting the internal parameter calibration model for adjusting the relationships between the fish-eye lens 212 and the CMOS sensor modules 214, the image stitching parameter model and the space depth transformation parameter model for interpreting the outer environment images, and accumulating the parameter data, automatically optimizing each parameter by means of a machine learning method in the panoramic fish-eye camera 21, and updating the parameter model by transmitting the optimized parameters to each panoramic fish-eye camera 21, a great amount of time and manpower for measurement and calibration can be decreased. Wherein the algorithm utilized by the machine learning comprises a Support Vector Machine (SVM).

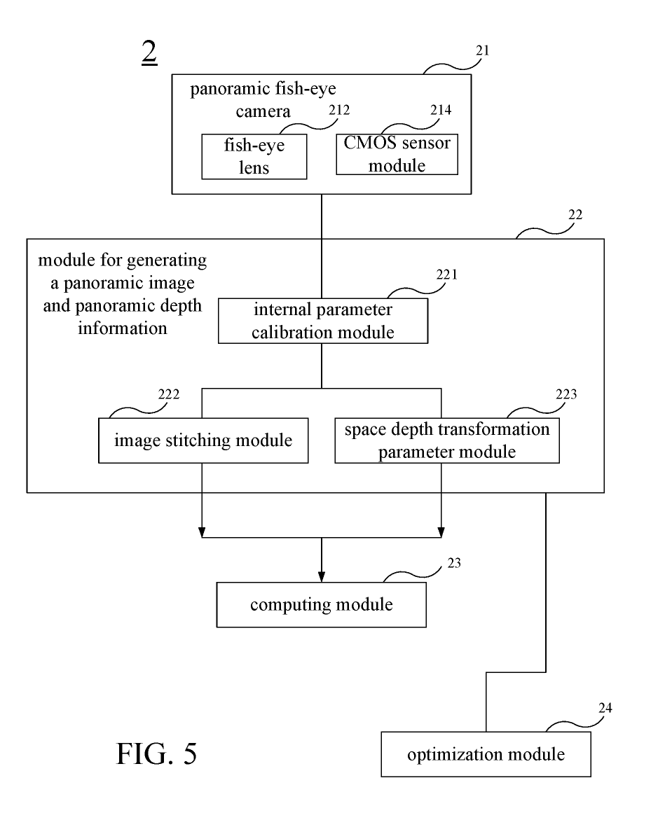

Referring to FIGS. 3 to 5, FIG. 3 is a front view drawing of a panoramic fish-eye camera according to another embodiment of the present invention. FIG. 4 is a top view drawing of a panoramic fish-eye camera according to another embodiment of the present invention. FIG. 5 is a system functional block diagram according to another embodiment of the present invention. Another category of the present invention provides an image calibrating, stitching and depth rebuilding system 2 of a panoramic fish-eye camera, utilized for calibrating a panoramic image to generate a 3D panoramic image which comprises panoramic depth information. The system 2 comprises a panoramic fish-eye camera 21, a module 22 for generating a panoramic image and panoramic depth information, and a computing module, wherein the module 22 comprises an internal parameter calibration module 221, an image stitching module 222, and a space depth transformation parameter module 223.

The panoramic fish-eye camera 21 comprises four fish-eye lens 212 and four CMOS sensor modules 214, wherein each one of the fish-eye lens 212 can be attached with a CMOS sensor module 214 and the intersection angle of the shooting directions of the neighboring fish-eye lens 212 is 90 degrees. The module 22 for generating a panoramic image and panoramic depth information is electrically connected with the panoramic fish-eye camera 21. The module 22 comprises an internal parameter calibration module 221, an image stitching module 222, and a space depth transformation parameter module 223, utilized for providing the panoramic fish-eye camera 21 with all the required parameters for calibrating the panoramic images to generate the 3D panoramic images. The computing module 23 is electrically connected with the module 22 for generating the panoramic image and the panoramic depth information, utilized for calibrating the panoramic images to generate the 3D panoramic image according to the parameters contained by the module 22 for generating the panoramic depth information.

The internal parameter calibration module 221 is utilized for storing the aforementioned internal parameter calibration model and executing the coordinate transformation between the fish-eye lens 212 and the CMOS sensor module 214 according to the above-mentioned parameter model toward the deformed images due to the shape of the fish-eye lens 212. The image stitching module 222 is utilized for storing the aforementioned image stitching parameter model, i.e. external parameter calibration model, and stitching the adjusted panoramic images by means of the internal parameter calibration module 221 to generate a panoramic picture P1. The space depth transformation parameter module 223 is utilized for storing the above-mentioned space depth transformation parameter model to find out the corresponding relationships between a 2D planar image and an actual object depth in 3D space shot by the panoramic fish-eye camera 21, to get the panoramic depth information I1 of each pixel in the panoramic images.

After the above-mentioned models are built up, the computing module 23 is utilized for calibrating and stitching the panoramic picture P1 and the panoramic depth information I1 to generate the 3D panoramic image.

The image calibrating, stitching and depth rebuilding system 2 of a panoramic fish-eye camera of the present invention further comprises an optimization module 24, wherein the optimization module 24 is electrically connected with the module 22 for generating the panoramic image and the panoramic depth information. The optimization module 24 can accumulate a parameter data by means of continuously collecting the internal parameter calibration model, the image stitching parameter model and the space depth transformation parameter model stored in respective module 22 for generating the panoramic image and the panoramic depth information from each panoramic fish-eye camera 21. And then the parameters of the internal parameter calibration model, the image stitching parameter model and the space depth transformation parameter model are optimized by means of a machine learning method. After optimizing the parameters, the optimized parameters are utilized for replacing the internal parameter calibration model, the image stitching parameter model and the space depth transformation parameter model to make the 3D panoramic images stitched by the computing module 23 better.

The computing module 23 can be a cloud computing module or stored in a panoramic fish-eye camera, so the panoramic images can be calibrated to generate a 3D panoramic image by utilizing the computing module. The internal parameter calibration module 221, the image stitching module 222 and the space depth transformation parameter module 223 are integrated as a single chip or can be a single chip respectively. The algorithm utilized by the machine learning comprises a Support Vector Machine (SVM).

To sum up, an image calibrating, stitching and depth rebuilding method of a panoramic fish-eye camera and a system thereof are provided by the present invention. A panoramic image stitching parameter model (external parameter calibration model) is computed by means of finding out an internal parameter calibration model between the semi-spherical shaped fish-eye lens and the planar CMOS sensor modules of the panoramic fish-eye camera and a panoramic optical target space shot by the panoramic fish-eye camera, and by means of building a space depth transformation parameter module between a 2D planar image and an object depth in 3D space at the same time. Finally, the internal parameter calibration model, the panoramic image stitching parameter model (external parameter calibration model) and the space depth transformation parameter model are utilized to calibrate a panoramic image shot by the panoramic fish-eye camera for generating a 3D panoramic image.

Compared to the prior art, the panoramic images and depth information can be acquired quickly by the present invention, and the calibration parameters can be optimized by means of a machine learning method to accumulate data. Therefore, the precision can be promoted, so as to simplify the algorithm of 3D depth and to enhance the computing efficiency. Furthermore, the simplified algorithm of 3D depth can be implanted to be executed on a single-chip, so the image calibration system of the fish-eye camera can be calibrated instantly and portable conveniently.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the meets and bounds of the appended claims.

What is claimed is:

1. An image calibrating, stitching and depth rebuilding method of a panoramic fish-eye camera utilized for calibrating a panoramic image shot by a panoramic fish-eye camera to a 3D panoramic image, wherein the panoramic fish-eye camera comprises four fish-eye lens and four CMOS sensor modules, comprising the following steps:
establishing a panoramic optical target space;
utilizing the panoramic fish-eye camera for shooting the panoramic image of the panoramic optical target space;
establishing an internal parameter calibration model of the panoramic fish-eye camera, wherein the internal parameter calibration model is the coordinate transformation model between the fish-eye lens and the CMOS sensor modules of the panoramic fish-eye camera;
establishing an image stitching parameter model of the panoramic image and the panoramic optical target space, wherein the image stitching parameter model is used for a panoramic image stitching parameter model by means of computing the relationships between the physical body and the space coordinate of the four fish-eye lens from the images shot by the panoramic fish-eye camera;
establishing a space depth transformation parameter model of the panoramic image and the panoramic optical target space, wherein the space depth transformation parameter model is a transformation model between a 2D planar image and an object depth in 3D space; and
utilizing the image stitching parameter model, the space depth transformation parameter model and the internal parameter calibration model to calibrate the panoramic image for generating a 3D panoramic image.

2. The image calibrating, stitching and depth rebuilding method of a panoramic fish-eye camera of claim 1, further comprising the following step: optimizing the parameters.

3. The image calibrating, stitching and depth rebuilding method of a panoramic fish-eye camera of claim 2, wherein the step of optimizing the parameters comprises the following step: collecting the internal parameter calibration model, the image stitching parameter model and the space depth transformation parameter model from each of the panoramic fish-eye cameras.

4. The image calibrating, stitching and depth rebuilding method of a panoramic fish-eye camera of claim 3, wherein the step of optimizing the parameters comprises the following step: optimizing the internal parameter calibration model, the image stitching parameter model and the space depth transformation parameter model by means of a machine learning, wherein the algorithm utilized by the machine learning comprises a Support Vector Machine.

5. The image calibrating, stitching and depth rebuilding method of a panoramic fish-eye camera of claim 4, wherein the step of optimizing the parameters comprises the following step: updating the internal parameter calibration model, the image stitching parameter model and the space depth transformation parameter model.

6. An image calibrating, stitching and depth rebuilding system of a panoramic fish-eye camera, utilized for calibrating a panoramic image to a 3D panoramic image, comprising:
a panoramic fish-eye camera, comprising four fish-eye lens and four CMOS sensor modules, wherein the intersection angle of the shooting directions of the neighboring fish-eye lens is 90 degrees;
a module for generating panoramic image and panoramic depth information, electrically connected with the panoramic fish-eye camera, comprising:
an internal parameter calibration module, an internal parameter calibration model stored therein, utilized for providing the required parameters of the coordinate transformation model between the fish-eye lens and the CMOS sensor modules of the panoramic fish-eye camera;
an image stitching module, an image stitching parameter model stored therein, utilized for stitching the panoramic images shot by the panoramic fish-eye camera to a panoramic picture; and
a space depth transformation parameter module, a space depth transformation parameter model stored therein, utilized for providing a transformation model between a 2D planar image and the object depth in 3D space to the panoramic fish-eye camera, to get the panoramic depth information of each pixel in the panoramic images; and
a computing module, electrically connected with the module for generating the panoramic image and the panoramic depth information, utilized for calibrating and stitching the panoramic picture and the panoramic depth information to generate the 3D panoramic image.

7. The image calibrating, stitching and depth rebuilding system of a panoramic fish-eye camera of claim 6, further comprising an optimization module, electrically connected with the module for generating the panoramic image and the panoramic depth information, wherein the optimization module can accumulate a parameter data by means of collecting the internal parameter calibration model, the image stitching parameter model and the space depth transformation parameter model from each of the panoramic fish-eye cameras, and then optimizes the parameter data by a machine learning method.

8. The image calibrating, stitching and depth rebuilding system of a panoramic fish-eye camera of claim 7, wherein the algorithm utilized by the machine learning comprises a Support Vector Machine.

9. The image calibrating, stitching and depth rebuilding system of a panoramic fish-eye camera of claim 6, wherein the internal parameter calibration module, the image stitching module and the space depth transformation parameter module are integrated as a single chip or can be a single chip respectively.
